(19) United States
(12) Patent Application Publication
(10) Pub. No.: US 2012/0244277 A1
(43) Pub. Date: Sep. 27, 2012

(54) Method for Balancing a Mass Component by Means of CMT Welding

(75) Inventors: Christian Anders, Backnang (DE); Tobias Buban, Stuttgart (DE); Gerd Eyssele, Remseck (DE); Michael Gruener, Bad Ueberkingen (DE); Ralf Herrmann, Stuttgart (DE); Martin Holdgruen, Stuttgart (DE); Hans-Peter Merten, Senscheid (DE); Ulrich Schweizer, Wangen (DE); Heiko Steinmetz, Ohmden (DE); Christian Zoeller, Stuttgart (DE)

(73) Assignee: Daimler AG, Stuttgart (DE)

(21) Appl. No.: 13/510,853

(22) PCT Filed: Oct. 9, 2010
(86) PCT No.: PCT/EP2010/006175

§ 371 Date: Jun. 13, 2012

(30) Foreign Application Priority Data
Nov. 20, 2009 (DE) 10 2009 054 103.9

(51) Int. Cl. B05D 5/12

(52) U.S. Cl. 427/123

(57) ABSTRACT

A rotating mass component with high balancing quality is provided. The balancing is performed in a substantially automated manner and without chip formation. A method for balancing a rotating mass component, such as a rotor is achieved by deposition welding of welding points on the mass component. The mass symmetry respective to the rotation axis is improved. The deposition welding takes place through cold metal transfer welding, in particular of a plurality of individual mass points.

### BACKGROUND AND SUMMARY OF THE INVENTION

Exemplary embodiments of the present invention relate to a method for balancing a rotating mass component by means of deposition welding of welding points on the mass component, whereby the mass symmetry of said mass component is improved in relation to the rotation axis.

Rapidly rotating components require precise balancing, after their production, for smooth running and to avoid oscillations and vibrations. This is the only way to achieve the necessary comfort in motor vehicle drives and the desired lifespan of the components and add-on parts.

Particularly high balancing qualities are frequently required for electric motors of hybrid and electric vehicles. In order to achieve these balancing qualities it is necessary to apply or remove, during the balancing process, the respectively determined mass flexibly in relation to place and exactly dosed in relation to mass.

There are two principally different method variants for balancing: The first variant consists of “negative balancing”, wherein mass is removed in a targeted manner. The second variant consists of “positive balancing”, wherein mass is added in a targeted manner.

In order to achieve particularly high balancing qualities negative balancing is commonly used, for example, by drilling. By determining the drilling depth and number or diameter of the drill holes it is possible to react in a fully automated way flexibly and precisely to the requirements of each individual balancing operation.

The disadvantage of negative balancing is, however, that constructively adequate material must be kept for removal. Additionally, negative balancing leads to component weakening at the points to be removed and to chip formation. Contamination, such as due to chips, can lead to functional impairments, particularly with electric machines, which necessitates a very expensive and careful production process.

Greater resources have been required using positive balancing to achieve high balancing qualities. Positive balancing can be carried out by a plurality of methods. For example, welding of balancing plates can take place using resistance or laser welding. A disadvantage of this technique is it requires a very large multitude of variants in relation to weight of the plates and special handling of the balancing plates.

Positive balancing is also possible using deposition welding by means of conventional MIG/MAG welding. European Patent Publication No. EP 01 704 014 A1 discloses different welding processes combined with each other. A cold metal transfer welding process is mentioned as a welding process besides MIG/MAG.

Positive balancing can also be achieved using balancing plates that are stuck on or adhesive can be applied in a dosed manner. A disadvantage with these applied masses, however, is rapid ageing as well as low density and resistance to oils, fats and fuels.

European Patent Publication No. EP 01 850 998 A1 discloses a method for controlling and/or regulating a welding unit and also a welding unit. The welding unit has a welding wire, whereby after ignition of an arc a cold metal transfer welding process (CMT) is carried out, wherein the welding wire is conveyed in the direction of the workpiece as far as contact therewith. Subsequently, after the formation of a short circuit during a short circuit phase, the wire conveying direction is reversed and the welding wire is moved away from the workpiece until the short circuit is broken. The current flow for the welding current is thereby controlled so that, during an arc phase, initial fusing of the welding wire, thus droplet formation, is possible.

Exemplary embodiments of the present invention achieve balancing of a rotating mass component without chip formation and without component weakening with the highest possible balancing quality and a high degree of automation.

In accordance with exemplary embodiments of the present invention, a method is provided for balancing a rotating mass component by deposition welding of welding points on the mass component, whereby the mass symmetry thereof is improved having regard to the rotation axis, wherein the deposition welding takes place through cold metal transfer welding.

In an advantageous way a very flexibly usable positive balancing is thus possible. The cold metal transfer (CMT) welding is furthermore very easily automated as the mass to be applied and the position of the individual welding points can be calculated automatically very well. Additionally, a particularly high balancing quality can be achieved with the CMT welding. Further advantages consist in that chip formation and component weakening do not occur. In particular, however, no material is to be kept back, as in negative balancing, so that there is overall a weight saving.

The method according to the invention can preferably be used with a rotor of an electric motor as a rotating mass component. In particular the electric motor can be a drive motor for a motor vehicle. It is further favorable if a mass necessary for balancing is welded on through a plurality of individual mass points. The number and position of the individual mass points can hereby be automatically determined.

### BRIEF DESCRIPTION OF THE DRAWING FIGURES

The present invention is explained in greater detail below by reference to the attached drawings, in which:

FIG. 1 shows a rotor for negative balancing according to the prior art;

FIG. 2 a positively balanced rotor according to the present invention and

FIG. 3 the rotor of FIG. 2 in another view.

### DETAILED DESCRIPTION

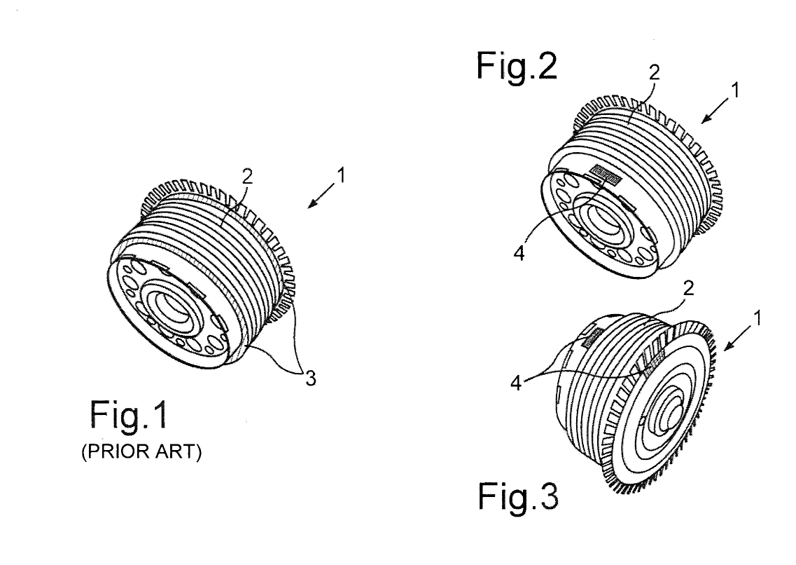

The example embodiments described in greater detail below constitute preferred embodiments of the present invention. Initially, however, for better understanding of the invention, by reference to FIG. 1 a known negative balancing method is explained in greater detail.

FIG. 1 shows a rotor 1 of an electric motor for driving a motor vehicle. The rotor 1 has here at both axial ends of the magnet arrangement 2 respectively a balancing ring 3. During balancing, points are determined on the balancing rings, at which material can be removed from the balancing rings 3 by drilling. Not only the position of any drill holes but also the number thereof and/or size is thereby determined. As already mentioned above, negative balancing has the disadvantage that initially balancing rings 3 are to be provided on the rotor 1, i.e., corresponding mass is to be kept on the mass component. This leads to a considerable weight increase. If the retained material, here the balancing rings 3, are significantly drilled during balancing this leads to a component weakening which is dangerous under certain circumstances.

For the abovementioned reasons positive balancing by means of controlled CMT welding technology is employed with the present invention. Precisely the mass that is required for balancing is thereby applied to the mass component. This results in a considerable weight saving compared to negative balancing.

In case of controlled CMT welding technology there is the possibility of welding defined mass points in the desired volume. In FIGS. 2 and 3 respective fields 4 with welded on mass points can be seen on the rotor 1. These fields 4 can be formed at all appropriate points of the rotor 1, in particular of the rotor carrier. In the example of FIGS. 2 and 3 there is such a field 4 with mass points on a peripheral outer surface and another field 4 on the end face of the rotor 1.

Depending upon the required weight the respective number of mass points can be applied in the corresponding position. Due to the flexibility in relation to the number of the mass points and their location, automation can be easily carried out. Through the small mass points, which can be achieved in the CMT weld technology, a very high balancing quality can additionally be achieved. The application of heat in the CMT welding process is additionally very low in comparison with conventional MIG/MAG welding. For example, a very low vibration electric motor can thus be realized with a long lifespan of the components.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-5. (canceled)

6. A method for balancing a rotating mass component, comprising:
deposition welding of welding points on the mass component in a manner such that a mass symmetry of the mass component is improved in relation to a rotation axis,
wherein the deposition welding is a cold metal transfer welding.

7. The method according to claim 6, wherein the rotating mass component is a rotor of an electric motor.

8. The method according to claim 7, wherein the electric motor is a drive motor for a motor vehicle.

9. The method according to claim 6, wherein a mass required for balancing is welded on at a plurality of individual mass points.

10. The method according to claim 9, wherein a number and position of the individual mass points are automatically determined.
